(19) United States
(12) Patent Application Publication
(10) Pub. No.: US 2014/0238765 A1
(43) Pub. Date: Aug. 28, 2014

(54) ELECTRIC CAR

(71) Applicant: HONDA MOTOR CO., LTD., Tokyo (JP)

(72) Inventors: Ryoji Tomokage, Utsunomiya-shi (JP); Yuuichi Suzuki, Utsunomiya-shi (JP)

(73) Assignee: HONDA MOTOR CO., LTD., Tokyo (JP)

(21) Appl. No.: 13/991,079

(22) PCT Filed: Nov. 2, 2012
(86) PCT No.: PCT/JP2012/078492

§ 371 Date: May 31, 2013

(30) Foreign Application Priority Data
Nov. 14, 2011 (JP) 2011-248173

(51) Int. Cl. B60K 28/14

(52) U.S. Cl. CPC B60K 28/14
USPC 180/232

(57) ABSTRACT

In an electric car, a power control unit includes: a heat sink that has an electric device fixed thereto and performs a heat exchange with the electric device; and a case that is attached to a surface of the heat sink to which the electric device is fixed and that covers the electric device. A reserve tank that stores a circulation liquid is attached to a front end surface of the heat sink via a bracket, a bulkhead frame that retains a radiator is provided in a vehicle width direction ahead of the reserve tank, the reserve tank is arranged at a position that overlaps the bulkhead frame in a front view, and a front surface of the power control unit has a protruding portion that protrudes forward, at a position that overlaps the reserve tank and the bulkhead frame in a front view.

### TECHNICAL FIELD

The present invention relates to an electric car.

Priority is claimed on Japanese Patent Application No. 2011-248173, filed Nov. 14, 2011, the content of which is incorporated herein by reference.

### BACKGROUND ART

In the related art, for example, a motor, and a power control unit (hereinafter referred to as PCU) that is provided above the motor to control driving of the motor are stored in a motor room arranged at a front portion of a vehicle body in an electric vehicle on which storage batteries, such as a battery, or fuel cells are mounted (for example, refer to PTL 1).

In such a vehicle, for example, in the case of a front collision (hereinafter referred to as front collision), peripheral members ahead of the PCU are pushed in toward the PCU by the collision load input from the front portion of the vehicle body.

In contrast, for example, PTL 2 discloses a configuration in which a reserve tank is arranged ahead of an electrical component unit, and when the peripheral members are pushed in toward the electrical component unit at the time of a front collision, the reserve tank is made to function as a shock absorbing material as the peripheral members come into contact with the reserve tank before the electrical component unit.

### CITATION LIST

### Patent Literature

[PTL 1] Japanese Unexamined Patent Application, First Publication No. 2004-181979

[PTL 2] Japanese Unexamined Patent Application, First Publication No. 2007-99239

### SUMMARY OF INVENTION

### Technical Problem

Incidentally, the above-described reserve tank is a part of which the length along the vehicle width direction is smaller than that of the PCU, while a bulkhead or the like among the peripheral members provided ahead of the PCU is a part of which the length along the vehicle width direction is greater than that of at least the reserve tank.

Therefore, when the bulkhead is pushed in toward the PCU at the time of a front collision, it may be difficult to protect the entire PCU in the vehicle width direction by the reserve tank. That is, although the contact between the bulkhead and the PCU can be suppressed by the reserve tank in the portion of the PCU that overlaps the reserve tank in a front view, the bulk head and the PCU may contact each other in the portion of the PCU that does not overlap the reserve tank. As a result, the PCU may be damaged.

An object of aspects of the invention is to provide an electric car that can effectively alleviate the impact applied to a power control unit (PCU) at the time of a front collision or the like by a reserve tank, and can protect the power control unit.

### Solution to Problem

An electric car of aspects related to the invention adopts the following configurations in order to achieve the above object.

(1) An aspect related to the invention is an electric car in which a power control unit accommodating an electric device within a case is arranged within a vehicle front motor room. The power control unit includes: a heat sink that has the electric device fixed thereto and performs a heat exchange with the electric device; and the case that is attached to a surface of the heat sink to which the electric device is fixed and that covers the electric device. A reserve tank that stores a circulation liquid is attached to a front end surface of the heat sink via a bracket, a bulkhead frame that retains a radiator is provided in a vehicle width direction ahead of the reserve tank, the reserve tank is arranged at a position that overlaps the bulkhead frame in a front view, and a front surface of the power control unit has a protruding portion that protrudes forward, at a position that overlaps the reserve tank and the bulkhead frame in a front view.

(2) In the aspect of the above (1), the protruding portion may be provided within the case, and in the case, an electric connector for supplying electric power to the electric device may be arranged at a position that overlaps the protruding portion in a front view.

(3) In the aspect of the above (1) or (2), the protruding portion may have a plate thickness greater than other regions of the case.

(4) In the aspect of any one of the above (1) to (3), the protruding portion may be provided in the case, and a contactor that switches an electrical connection between a battery provided in the vehicle and an external power source or an external device may be arranged at a position that overlaps the protruding portion in a front view within the case.

### Advantageous Effects of Invention

According to the aspect of the above (1), in a case where the bulkhead frame moves toward the power control unit at the time of collisions, such as a front collision, the bulkhead frame will come into contact with the reserve tank before the power control unit. For this reason, the collision load that acts on the power control unit can be alleviated by the reserve tank, and the power control unit can be protected.

Particularly, the protruding portion that protrudes forward is formed at the position of the front surface of the power control unit that overlaps the reserve tank and the bulkhead frame. Thereby, in a case where the bulkhead frame comes into contact with the reserve tank, the collision load can be alleviated by the reserve tank, as described above, at the portion of the front surface of the power control unit that is located at the protruding portion along the vehicle width direction, and the distance along the front-and-rear direction between the bulkhead frame and the power control unit can be secured at portions other than the protruding portion. Accordingly, since the bulkhead frame can be kept from directly contacting the power control unit over the entire power control unit in the vehicle width direction, the power control unit can be protected. Accordingly, since it is not necessary to make the rigidity or strength of the power control unit itself high, the power control unit can be protected and low costs and weight reduction can also be achieved.

According to the aspect of the above (2), by arranging the electric connector at a position that overlaps the protruding portion in a front view in the case, the collision load that acts on the electric connector can be alleviated by the reserve tank. Accordingly, the electric connector can be reliably protected.

According to the aspect of the above (3), the rigidity of the protruding portion can be made high by making the plate thickness of the protruding portion of the case greater than that of other regions. For this reason, even if the collision load input to the reserve tank is transmitted to the protruding portion, the power control unit can be kept from being damaged.

According to the aspect of the above (4), by arranging the contactor that is not used during vehicle traveling among electric devices at a position that overlaps the protruding portion in a front view, other electric devices to be used during vehicle traveling are arranged at positions to avoid the protruding portion. That is, since the electric device to be used during vehicle traveling is arranged at a portion that does not easily come into contact with the bulkhead frame at the time of a collision, the power control unit can be reliably protected.

### BRIEF DESCRIPTION OF DRAWINGS

FIG. 1 is a schematic configuration view showing a front portion side surface of an electric car in the present embodiment.

FIG. 2 is a plan view of a motor room.

FIG. 3 is a perspective view of the motor room as seen from the front.

FIG. 4 is a partially fractured cross-sectional view of the motor room as seen from the right.

FIG. 5 is a perspective view of a heat sink housing as seen from below.

FIG. 6 is a plan view when a portion of an upper cover is removed and the inside of a protruding partition portion is seen.

### DESCRIPTION OF EMBODIMENTS

Next, an embodiment related to the invention will be described with reference to the drawings.

Electric Car

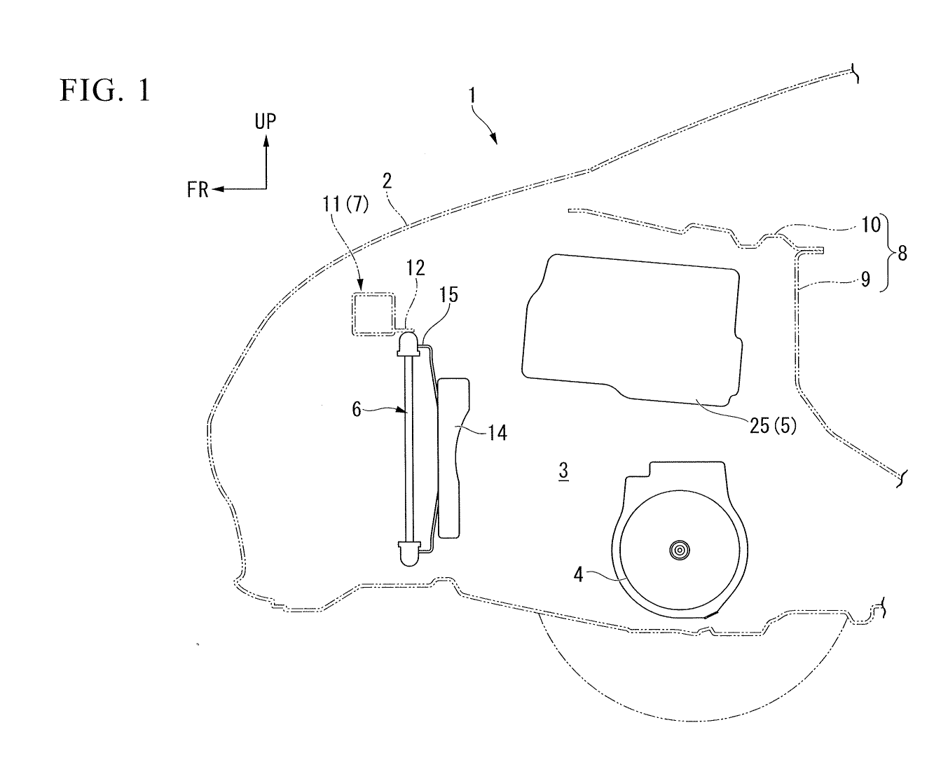

FIG. 1 is a schematic configuration view of a front portion of an electric car in the present embodiment as seen from the side. In addition, directions, such as the front, the rear, the left, and the right, in the following description are the same as directions in a vehicle unless particularly mentioned. Additionally, an arrow denoted by FR in the drawing indicates a front direction of a vehicle, and an arrow denoted by UP indicates an upward direction of the vehicle.

As shown in FIG. 1, in the electric car (vehicle) 1 of the present embodiment, a front portion of a vehicle body 2 is provided with a motor room (vehicle front motor room) 3. A motor 4 as a drive source, a PCU 5 that is arranged above the motor 4 to control driving of the motor 4, and a radiator 6 that is arranged ahead of the motor 4 and the PCU 5 are mainly stored within the motor room 3.

In addition, a rear portion of the motor room 3 is provided with a dashboard 8 that partitions a vehicle interior that is not shown and the motor room 3 in the front-and-rear direction. The dashboard 8 includes a lower dashboard 9 that is provided along the up-and-down direction behind the PCU 5, and an upper dashboard 10 that is provided forward from an upper end portion of the lower dashboard 9.

The motor 4 is formed in a cylindrical shape, and is elastically supported by the vehicle body 2 via a vibration-proofing member (not shown) in a state where a rotating shaft thereof is turned to the right-and-left direction.

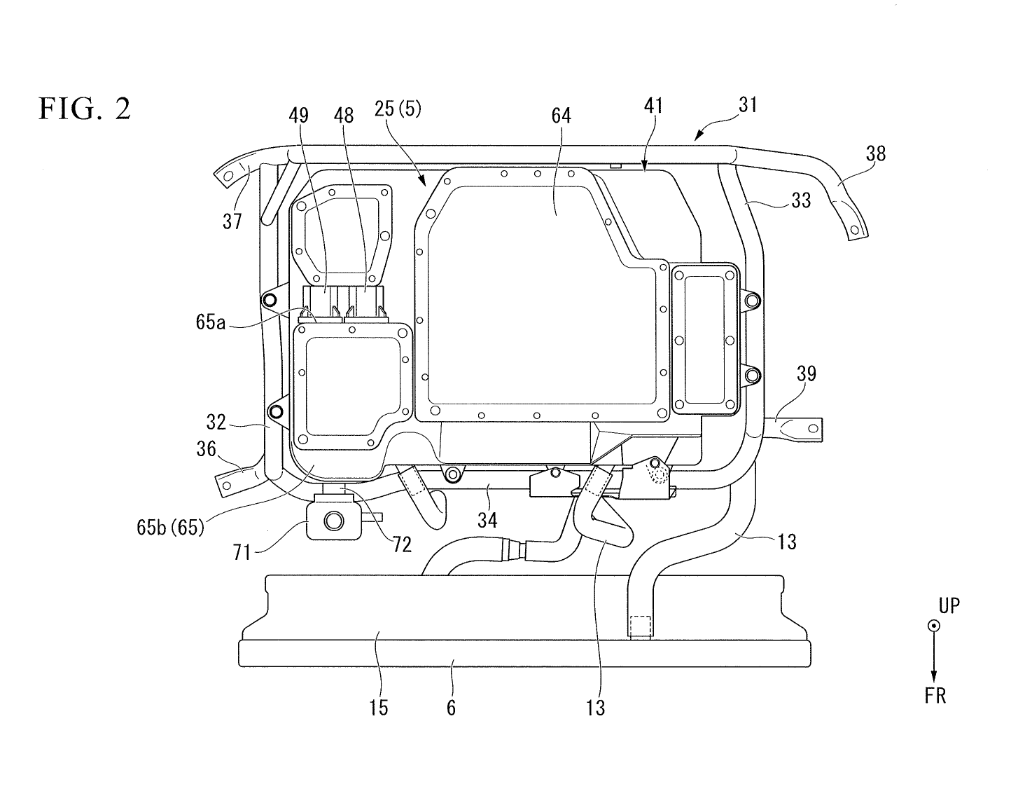

FIG. 2 is a plan view of the inside of the motor room.

As shown in FIGS. 1 and 2, the radiator 6 is formed in a rectangular plate shape of which the thickness direction is the front-and-rear direction, and performs a heat exchange between a refrigerant and the open air that is traveling wind, thereby cooling the refrigerant that circulates between the radiator 6, the motor 4, and the PCU 5. The radiator 6, the motor 4, and the PCU 5 are connected by a refrigerant piping 13, and the refrigerant flows between the radiator 6, the motor 4, and the PCU 5 by driving of a water pump that is not shown.

As shown in FIG. 1, the above-described radiator 6 is supported by a bulkhead frame 7. The bulkhead frame 7 has a frame shape that is arranged so as to surround the radiator 6 as seen from the front-and-rear direction, in front of the radiator 6, and includes an upper bulkhead 11 that is provided along the right-and-left direction above the radiator 6. The upper bulkhead 11 is a member with closed section structure, and is formed such that the length thereof along the right-and-left direction is longer than the radiator 6. A stay 12 is provided toward the rear in the upper bulkhead 11, and the radiator 6 is coupled to the upper bulkhead 11 via the stay 12. In addition, a fan shroud 15 that covers the cooling fan 14 and a portion between the rear of the radiator 6 and the cooling fan 14 is provided behind the radiator 6.

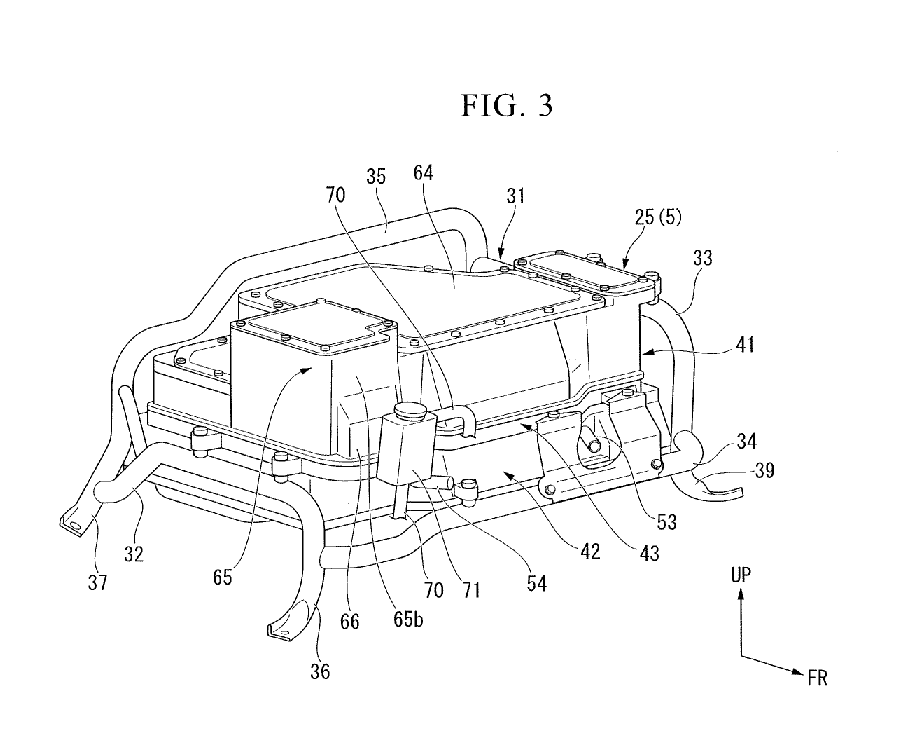

FIG. 3 is a perspective view of the motor room as seen from the front.

As shown in FIGS. 2 and 3, the PCU 5 controls the driving of the motor 4, for example, by converting direct-current power, which is supplied from a high-voltage battery (not shown) provided at a lower portion within the vehicle interior, to three-phase (U-phase, V-phase, and W-phase) alternating-current power and by supplying the converted alternating-current power to the motor 4. Specifically, the PCU 5 includes a housing 25 in which a plurality of electric devices are stored, and the housing 25 is supported by the vehicle body 2 via a unit supporting frame 31.

The unit supporting frame 31 is a pipe-like member, and is provided so as to surround the whole periphery of the PCU 5, at a central portion in the right-and-left direction within the motor room 3 as seen from the up-and-down direction. Specifically, the unit supporting frame 31 has a right side supporting frame 32 that is provided on the right with respect to the PCU 5, a left side supporting frame 33 that is provided on the left, a front supporting frame 34 that joins front end portions of the respective side supporting frames 32 and 33 to each other, and a rear supporting frame 35 that joins rear end portions of the respective side supporting frames 32 and 33 to each other.

Leg portions 36 to 39 are respectively provided downward at joining portions of the respective supporting frames 32 to 35, that is, respective angled portions of the unit supporting frame 31. The unit supporting frame 31 is fixed to side frames (not shown) of the vehicle body 2 at lower end portions of the respective leg portions 36 to 39, and thereby, the posture thereof is held. The housing 25 of the PCU 5 is fixed to suitable positions of the respective supporting frames 32 to 35, and thereby, is supported inside the unit supporting frame 31.

As shown in FIG. 2, the housing 25 of the PCU 5 is made of an aluminum material or the like, and is formed in a rectangular parallelepiped shape of which the right-and-left direction (vehicle width direction) is the longitudinal direction. Specifically, the housing 25 includes an upper case (case) 41, a lower case 42 that is arranged below the upper case 41, and a heat sink housing (heat sink) 43 that partitions the upper case 41 and the lower case 42, and is configured so as to be split into three stages along the up-and-down direction. The above-described electric devices are covered with the upper case 41 and the lower case 42, respectively.

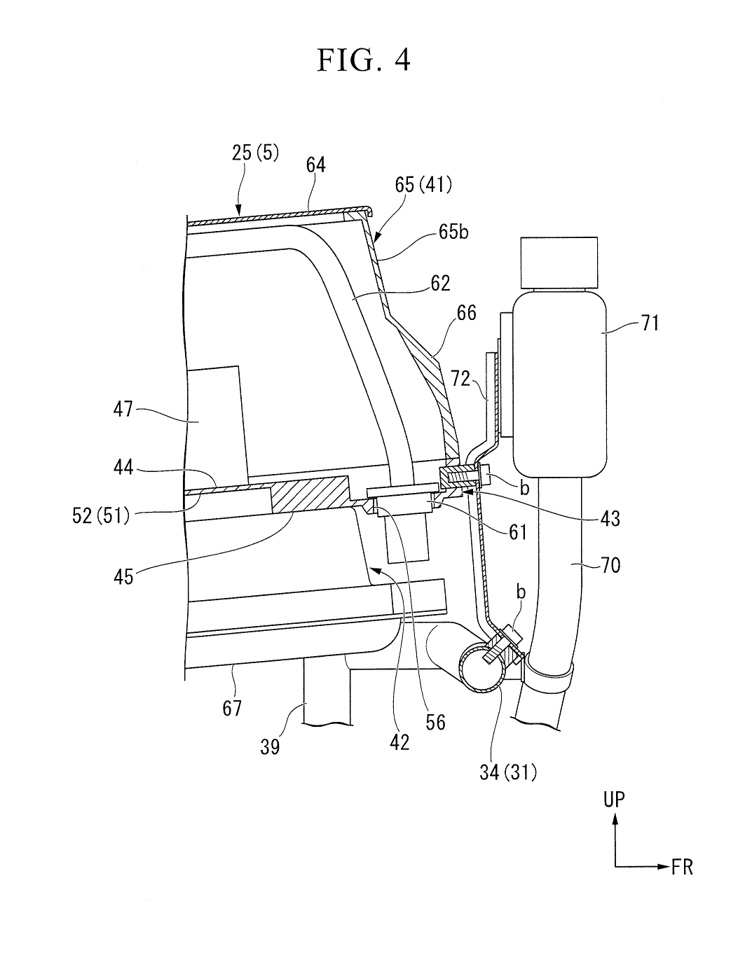

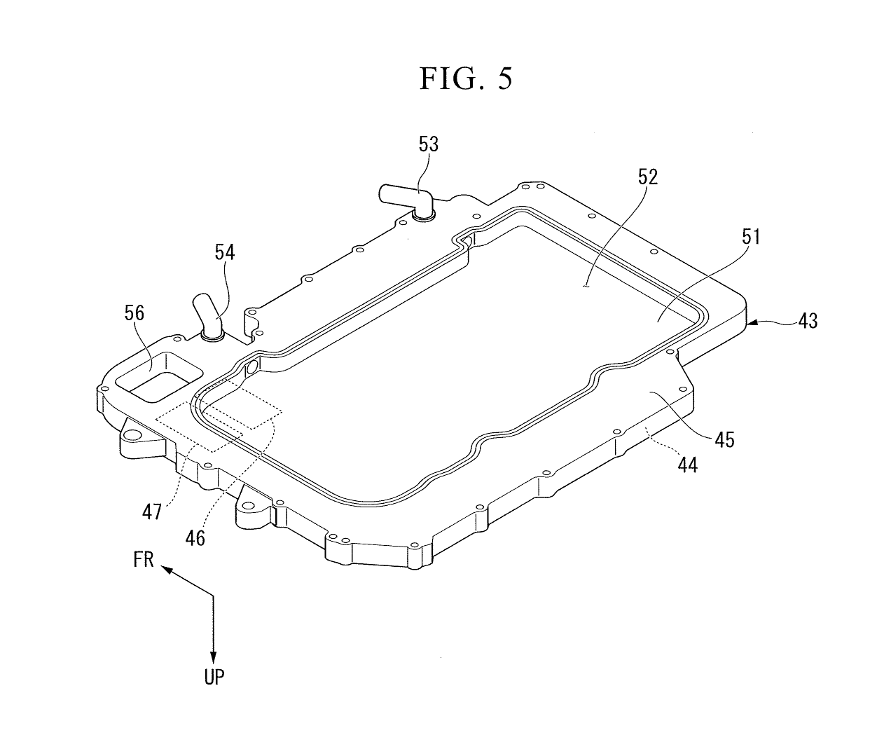

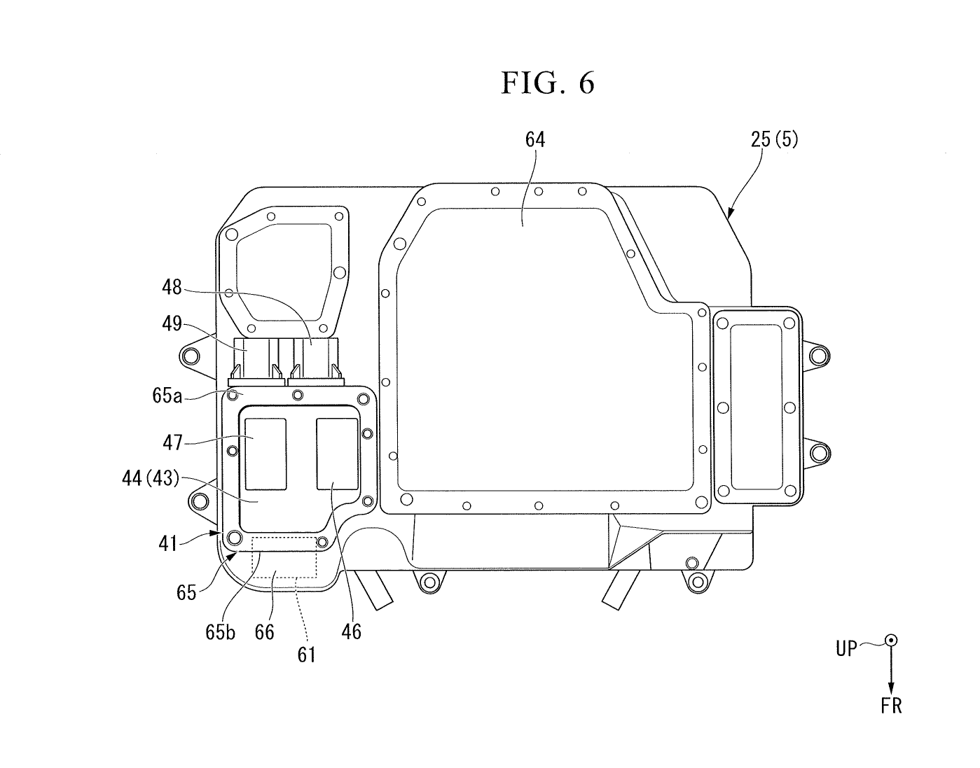

FIG. 4 is a partially fractured cross-sectional view of the motor room 3 as seen from the right, and FIG. 5 is a perspective view of the heat sink housing 43 as seen from below. FIG. 6 is a plan view when a portion of an upper cover 64 is removed and the inside of a protruding partition portion is seen.

As shown in FIGS. 4 to 6, the heat sink housing 43 is a rectangular plate-shaped member formed so as to have rigidity higher than the upper case 41 and the lower case 42, has the upper case 41 fixed to an upper surface (fixing surface) 44 side thereof, and has the lower case 42 fixed to a lower surface 45 side thereof. Additionally, the plurality of electric devices are fixed to the upper surface 44 of the heat sink housing 43. Specifically, a negative-side contactor 46 and a positive-side contactor 47 are installed side by side in the right-and-left direction at a front right portion of the upper surface 44 of the heat sink housing 43. The contactors (electric devices) 46 and 47 are connected between connectors 48 and 49 (to be described below) for making a connection of a high-voltage battery to an external power source and the high-voltage battery, and switch an electrical connection between both.

Additionally, as shown in FIGS. 4 and 5, a recessed portion 51 that is recessed upward is formed in a region excluding an outer peripheral portion of the lower surface 45 of the heat sink housing 43. A space surrounded by the recessed portion 51 and the upper surface of the lower case 42 constitutes a water jacket 52 through which the refrigerant supplied from the radiator 6 flows. That is, in the present embodiment, the water jacket 52 is arranged between the respective cases 41 and 42, and the respective electric devices are cooled as the heat generated by the electric devices stored in the respective cases 41 and 42 is radiated to the water jacket 52.

Additionally, as shown in FIG. 5, a refrigerant inlet port 53 that connects the inside and outside of the water jacket 52, and a refrigerant outlet port 54 are provided at a distance from each other in the right-and-left direction, at a front edge portion of the heat sink housing 43. The refrigerant inlet port 53 is provided on the left of the front edge portion of the heat sink housing 43. Specifically, a base end side of the refrigerant inlet port opens toward the inside of the water jacket 52, and a tip side thereof extends downward from the heat sink housing 43, is then bent forward, and opens forward. The refrigerant outlet port 54 has the same configuration as the above-described refrigerant inlet port 53, and is provided on the right of the front edge portion of the heat sink housing 43.

Thereby, the refrigerant supplied from the radiator 6 through the refrigerant piping 13 is supplied into the water jacket 52 via the refrigerant inlet port 53, and is discharged from the water jacket 52 via the refrigerant outlet port 54.

Additionally, as shown in FIGS. 4 and 5, a through hole 56 penetrating in the up-and-down direction is formed on the right of the refrigerant outlet port 54 of the front edge portion of the heat sink housing 43. An electric connector 61 for supplying electric power to the contactor 46 and 47 or the like among the above-described electric devices is attached to the inside of the through hole 56. The electric connector 61 is attached in a state where an attachment port thereof is directed downward outside the PCU 5, and an outside power line (not shown) that is routed outside the PCU 5 is configured so as to be attachable thereto and detachable therefrom. Additionally, an inside power line 62 for electrically connecting various electric devices within the PCU 5 is connected to the electric connector 61. Accordingly, the inside power line 62 and the outside power line are connected via the electric connector 61 so that electric power is supplied to the respective electric devices within the PCU 5.

As shown in FIG. 6, the upper case 41 is of a rectangular frame type that opens along the up-and-down direction, and an upper end opening portion thereof is covered with the upper cover 64. A front right portion of the upper case 41 has a rectangular shape in plan view and constitutes a protruding partition portion 65 that protrudes upward compared with other portions. The protruding partition portion 65 surrounds the front right portion of the above-described heat sink housing 43, that is, the peripheries of contactors 46 and 47 or the through hole 56.

Additionally, a negative-side connector 48 and a positive-side connector 49 connected to the respective contactors 46 and 47 inside the protruding partition portion 65 are provided at a rear wall portion 65a of the protruding partition portion 65 so that attachment ports thereof are directed rearward. The connectors 48 and 49 are provided side by side at positions corresponding to the respective contactors 46 and 47 in the right-and-left direction across the rear wall portion 65a. In addition, cables (not shown) that extend to charge ports provided in two places of the vehicle body for connection with the power source for quick charge are connected to the negative-side connector 48 and the positive-side connector 49.

On the other hand, a portion located at a lower portion of a front wall portion 65b of the protruding partition portion 65 constitutes the protruding portion 66 that protrudes forward. The protruding portion 66 inclines gradually toward the front as it goes downward from an intermediate portion of the front wall portion 65b in the up-and-down direction, and a lower end portion thereof is located at the forefront of the front surface of the PCU 5. The above-described through hole 56 is arranged at a portion located below the protruding portion 66 of the above-described heat sink housing 43. Additionally, the plate thickness of the protruding portion 66 of the upper case 41 is formed so as to be greater than those of other portions.

As shown in FIG. 4, the lower case 42 has a topped tubular shape that opens downward, and the outer shape of the lower case in a plan view is formed so as to be the same as that of the upper case 41, with the same material as the upper case 41. A lower end opening portion of the lower case 42 is covered with a lower cover 67, and the plurality of electric devices are stored within a space surrounded by the lower case 42 and the lower cover 67.

Here, as shown in FIGS. 2 to 4, a reserve tank 71 is arranged at a front right portion of the PCU 5, that is, at a portion that overlaps the protruding portion 66 of the upper case 41 and the above-described upper bulkhead 11 in a front view. The reserve tank 71 is connected in a flow channel 70 for a circulation liquid that performs a heat exchange with a heater (not shown) that is used for air-conditioning, to store the circulation liquid, and is formed in a box shape of which the up-and-down direction is the longitudinal direction. In this case, the length of the reserve tank 71 in the right-and-left direction is shorter than that of the housing 25 of the PCU 5 and the upper bulkhead 11. The reserve tank 71 is fixed to the housing 25 of the PCU 5 via a bracket 72 (refer to FIG. 4).

As shown in FIG. 4, the bracket 72 is a plate-shaped bracket that passes through the intermediate portion of the protruding portion 66 in the right-and-left direction and is provided along the up-and-down direction. A lower end portion of the bracket 72 is fixed to the front supporting frame 34 of the above-described unit supporting frame 31 via bolts b. The intermediate portion of the bracket 72 along the up-and-down direction is fixed to the front edge portion of the heat sink housing 43 via the bolts b.

Additionally, an upper end portion of the bracket 72 extends upward in a state where the upper end portion protrudes forward with respect to the protruding portion 66, and the reserve tank 71 is fixed to a front surface portion of the bracket.

Accordingly, the reserve tank 71 is arranged at a position that is apart from the protruding portion 66 and the upper bulkhead 11 between the protruding portion 66 of the PCU 5 and the above-described upper bulkhead 11 and that overlaps the above-described electric connector 61 or contactors 46 and 47 in a front view.

In this way, the present embodiment has a configuration in which the reserve tank 71 used for air-conditioning of the electric car 1 is attached to the front end edge of the heat sink housing 43.

According to this configuration, in a case where the bulkhead frame 7 has moved toward the PCU 5 at the time of collisions, such as a front collision, the bulkhead frame will come into contact with the reserve tank 71 before the PCU 5. For this reason, the collision load that acts on the PCU 5 can be alleviated by the reserve tank 71, and the PCU 5 can be protected.

Particularly, the present embodiment had a configuration in which the protruding portion 66 that protrudes forward is formed at the position of the front surface of the PCU 5 that overlaps the reserve tank 71 and the bulkhead frame 7.

According to this configuration, in a case where the bulkhead frame 7 contacts the reserve tank 71, collision load can be alleviated by the reserve tank 71, as described above, at the portion of the front surface of the PCU 5 that is located at the protruding portion 66 along the right-and-left direction, and the distance along the front-and-rear direction between the bulkhead frame 7 and the PCU 5 can be secured at portions other than the protruding portion 66. Accordingly, since the bulkhead frame 7 can be kept from directly contacting the PCU 5 over the entire PCU 5 in the right-and-left direction, the PCU 5 can be protected. Accordingly, since it is not necessary to make the rigidity or strength of the PCU 5 itself high, the PCU 5 can be protected and low costs and weight reduction can also be achieved.

Additionally, by attaching the reserve tank 71 to the heat sink housing 43 with comparatively high rigidity even in the housing 25, the housing 25 can be kept from being damaged even if the collision load input to the reserve tank 71 is transmitted to the heat sink housing 43.

Additionally, by arranging the electric connector 61 at a position that overlaps the protruding portion 66 in a front view in the upper case 41, the collision load that acts on the electric connector 61 can be alleviated by the reserve tank 71. Accordingly, the electric connector 61 can be reliably protected.

Moreover, the rigidity of the protruding portion 66 can be made high by making the plate thickness of the protruding portion 66 of the upper case 41 greater that that of other regions. For this reason, even if the collision load input to the reserve tank 71 is transmitted to the protruding portion 66, the housing 25 can be kept from being damaged.

Additionally, by arranging the contactors 46 and 47 that are not used during vehicle traveling among the electric devices at positions that overlap the protruding portion 66 in a front view, other electric devices to be used during vehicle traveling are arranged at positions to avoid the protruding portion 66 in the right-and-left direction. That is, since the electric devices to be used during vehicle traveling are arranged at portions that do not easily come into contact with the bulkhead frame 7 at the time of a collision, the PCU 5 (electric devices) can be reliably protected.

In addition, the technical scope of the invention is not limited to the above-described respective embodiments, and various changes can be made to the above-described embodiment without departing from the scope of the invention. That is, the configurations mentioned in the above-described embodiments are merely examples, and can be appropriately changed.

For example, the layout within the motor room 3, the configuration of the PCU 5, or the like can be appropriately changed.

Additionally, although the reserve tank 71 for air-conditioning has been described as an example in the above embodiment, the invention is not limited to this and can be applied to a reserve tank provided in a circulation liquid flow channel for cooling heat-generating parts.

Moreover, although the contactors 46 and 47 that switch the electrical connection between the high-voltage battery and the external power source have been described as an example in the above-described embodiment, the invention is not limited to this, and the contactors 46 and 47 may be contactors for external power supply that switch the electrical connection between a battery and an external device.

Additionally, although a case where the upper case 41, the lower case 42, and the heat sink housing 43 constitute the housing 25 has been described in the above-described embodiment, the invention is not limited to this, and the housing may be constituted by the heat sink housing 43 to which electric devices are fixed, and a case that covers the heat sink housing.

Moreover, the electric devices stored in the housing 25 can be appropriately changed.

In addition, the constituent elements in the above-described embodiment can be appropriately substituted with well-known constituent elements without departing from the scope of the invention.

### REFERENCE SIGNS LIST

1: ELECTRIC CAR (VEHICLE)

3: MOTOR ROOM (VEHICLE FRONT MOTOR ROOM)

5: PCU (POWER CONTROL UNIT)

6: RADIATOR

7: BULKHEAD FRAME

41: UPPER CASE (CASE)

43: HEAT SINK HOUSING (HEAT SINK)

44: UPPER SURFACE (FIXING SURFACE)

46, 47: CONTACTOR (ELECTRIC DEVICE)

61: ELECTRIC CONNECTOR

71: RESERVE TANK

72: BRACKET

1. An electric car in which a power control unit accommodating an electric device within a case is arranged within a vehicle front motor room,
wherein the power control unit includes:
a heat sink that has the electric device fixed thereto and performs a heat exchange with the electric device; and
the case that is attached to a surface of the heat sink to which the electric device is fixed and that covers the electric device,
wherein a reserve tank that stores a circulation liquid is attached to a front end surface of the heat sink via a bracket,
wherein a bulkhead frame that retains a radiator is provided in a vehicle width direction ahead of the reserve tank,
wherein the reserve tank is arranged at a position that overlaps the bulkhead frame in a front view, and
wherein a front surface of the power control unit has a protruding portion that protrudes forward, at a position that overlaps the reserve tank and the bulkhead frame in a front view,
wherein the protruding portion is provided within the case, and
wherein in the case, an electric connector for supplying electric power to the electric device is arranged at a position that overlaps the protruding portion in a front view.

2. (canceled)

3. The electric car according to claim 1, wherein the protruding portion has a plate thickness greater than other regions of the case.

4. The electric car according to claim 1, wherein
the protruding portion is provided in the case, and
a contactor that switches an electrical connection between a battery provided in the vehicle and an external power source or an external device is arranged at a position that overlaps the protruding portion in a front view within the case.

5. The electric car according to claim 3, wherein
the protruding portion is provided in the case, and
a contactor that switches an electrical connection between a battery provided in the vehicle and an external power source or an external device is arranged at a position that overlaps the protruding portion in a front view within the case.
